(19) United States
(12) Patent Application Publication
(10) Pub. No.: US 2012/0242748 A1
(43) Pub. Date: Sep. 27, 2012

(54) SCREEN PRINTED FUNCTIONAL MICROSYSTEMS

(75) Inventors: Ioannis Katakis, Tarragona (ES); Diego Bejarano, Tarragona (ES); Pablo Lozano Sanchez, Tarragona (ES)

(73) Assignee: UNIVERSITAT ROVIRA I VIRGILI, Tarragona (ES)

(21) Appl. No.: 13/498,487

(22) PCT Filed: Sep. 28, 2009
(86) PCT No.: PCT/IB09/07101

§ 371 Date: Jun. 6, 2012

(51) Int. Cl. B41J 2/135; B41M 1/12

(52) U.S. Cl. 347/44; 101/129

(57) ABSTRACT

Micro fluidic devices comprising three dimensional elements fabricated onto a substrate using thick film printing technology, e.g., screen printing, wherein the three dimensional elements possess both structural and functional properties.

The invention applies the fabrication of low-cost and easy-to-manufacture microsystems and microreactors using thick film techniques (serigraphy, screen-printing), where the structural components become functional elements able to perform a variety of functions related to their electrically conducting nature and electrochemical capabilities. Additional properties of the applied inks can also be used in microsystems and microreactors, such as filtration, molecular sieving, and the like.

### BACKGROUND OF THE INVENTION

Microfluidic devices have many advantages over conventional macro-sized systems for lab on a chip applications, and more recently for chemical process development [1,2]. Microfluidic devices are commonly fabricated by photolithography, dry and wet etching, injection molding, and hot embossing [3]. Such methods allow incorporation of functional elements such as sensors and actuators, valves and passive or active elements with different degrees of complexity and cost depending on if the final realisation is done on plastic or silicon. Work in the clean room is often required. For such methods, prototyping has a long iteration cycle, and it is feasible but laborious to produce hybrid devices especially incorporating sensors and active elements. For many applications the cost of these methods can be considerably high, and careful study of production volumes must be undertaken before product development. For many products, however, the low resolution required for the microfluidic elements (on the order of hundred microns) does not warrant the expense of high resolution techniques.

For the majority of high volume applications, such as disposable diagnostic devices, field instruments, food production quality control, versatile set-ups for process optimization, and catalyst selection, the acceptable cost for the application is at least one order of magnitude lower than what current manufacturing techniques allow. Microsystems are commonly manufactured by photolithographic techniques using a variety of methods. A perennial problem of microsystems manufactured in this way is the difficulty in obtaining hybrid devices that incorporate different materials with different functionalities. Cumbersome prototyping is another problem, as is the high investment needed for manufacturing. Such problems increase the cost of research and development, especially for lab-on-a-chip but also for certain microsystem and microreactor applications.

It would be highly desirable to generate a useful micro-fluidic device that is cost-effective, easy to produce, and versatile in application, for example in various microsystem and/or microreactor applications.

### BRIEF DESCRIPTION OF THE DRAWINGS

FIG. 1 is a table showing fixed 300 SDS (65/20) screen and squeege parameters.

FIG. 2 is a graph showing variation of printed line width as a function of screen width. Speed=6.40·10⁻² m/s. Print gap=1.0·10⁻³ m. Pressure=1.15·10⁴ Pa (n=40, 95% Confidence).

FIG. 3 is a graph showing variation of printed line thickness as a function of screen width. Speed=6.40·10⁻² m/s. Print gap=1.0·10⁻³ m. Pressure=1.15·10⁴ Pa. (n=40; 95% Confidence).

FIG. 4 is a graph showing variation of micro-channel width as a function of screen width. Speed=6.40·10⁻² m/s. Print gap=5.0·10⁻⁴ m. Pressure=4.23·10⁴ Pa (n=6; 95% Confidence).

FIG. 5 is a graph showing variation of micro-channel thickness as a function of screen width. Speed=6.40·10⁻² m/s. Print gap=5.0·10⁻⁴ m. Pressure=4.23·10⁴ Pa (n=6; 95% Confidence).

FIG. 6 is a graph showing variation of micro-channel width and thickness with optical alignment in multilayer printing. Speed=6.40·10⁻² m/s. Print gap=9.0·10⁻⁴ m. Pressure=3.08.10⁴ Pa. Ink viscosity=152800 cP. (n=20; 95% Confidence)

FIG. 7 is a schematic drawing of the microsystem and electron microscopy image of the micro-channel showing working and reference counter electrode

FIG. 8 shows confocal microscopy images monitoring the formation and diffusion of electrochemical reaction products within a micro-channel.

FIG. 9 is a graph showing electro-polymerization of polyaniline carried out by cyclic voltammetry on the electrode surface within the closed micro-channel. Internal screen-printed Ag/AgCl reference-counter electrode. Scan rate 0.1 V s⁻¹

FIG. 10 shows an ESEM image of the deposition of polyaniline in a screen-printed microsystem a) 2 cycles, b) 5 cycles, c) 20 cycles, d) ESEM image of the deposition of paramagnetic particles in a screen-printed microsystem

FIG. 11 is a graph showing Nyquist diagram showing the impedimetric signal obtained from the working electrode within a microsystem. Working electrode over which immunoparticles have been electrophoretically deposited for different times. Also shown is the impedance response when the deposited immunoparticles have been exposed to bacteria solutions. Initial potential set was 0.07 V with 0.005 V amplitude (vs. internal screen-printed Ag/AgCl reference-counter electrode) and frequency range from 10⁵ to 0.1 Hz. A solution of 1 mM potassium ferri/ferrocyanide in 0.1 M strontium nitrate was used as electrolyte

FIG. 12 is a Bode diagram for different impedances measured from different bacteria concentrations within the microsystem in aqueous solutions, with no supporting electrolyte. Initial potential set was 0.1 V with 0.24 V amplitude (vs. internal screen-printed Ag/AgCl reference-counter electrode) and frequency range from 10⁵ to 0.1 Hz.

FIG. 13 is a graph showing impedimetric monitoring of the lysis of different concentration of immobilized bacteria with time. Potential set was 0.07 V (vs. internal screen-printed Ag/AgCl reference-counter electrode) and frequency was fixed at 10¹ Hz. A solution of 1 mM potassium ferri/ferrocyanide in 0.1 M strontium nitrate was used as electrolyte.

FIG. 14 is a schematic drawing of the components and mechanisms integrated in the proposed platform for immobilization, lysis and electrochemical detection of pathogens.

FIG. 15 is a graph showing chronoamperometry results for the detection of bacteria immobilised and then lysed on the electrode surface inside the microsystem. Potential fixed at 0.2 V (vs. internal screen-printed Ag/AgCl reference-counter electrode). The solution inside he microsystem contains 5 mM Glucose and 2 mM PAPH with 1 mM MgCl₂ in pH 7 0.1. M PBS.

FIG. 16 shows a schematic drawing of the microsystem and electron microscopy image of the micro-channel showing working and reference counter electrode of Example 6.

FIG. 17 shows schematic drawings of the microsystem and photographs of the serial two-function micro-channel of Example 7, showing serial placement of multiple electrodes along the micro-channel, and including a dielectric between the electrodes in the series.

### SUMMARY OF THE INVENTION

The application of thick film printing, for example, screen-printing to the fabrication of microfluidic devices as described herein, provides a low cost technique enabling easy to produce and versatile microsystem and/or microreactor applications.

Microsystems comprising 3-dimensional elements produced via thick film printing techniques, such as screen printing are produced by the methods described herein, and demonstrate that the ability of such techniques to produce useful elements having a three dimensional nature with versatility and low cost for the fabrication of functional microsystems and microreactors.

As described herein, microsystems with dimensions on the order of tens to hundreds of microns were fabricated that, while maintaining their structural duties, could readily incorporate functionalities through simple in situ modification processes. Applicants have discovered that it is possible to use thick film/screen printing technology to build up a three dimensional ink deposit structure on a substrate using multiple passes of the printer, without compromising the ability of the ink deposit structure to exhibit both functional (e.g., channel) and functional (e.g., electrode) properties. The design and optimization of fabrication parameters can be optimized according to the final custom applications.

Microsystems of the invention utilize the 3-dimensional nature of the thick film printed elements to fabricate structural walls having a plurality of layers, for example 5,6,7,8,9,10 layers, generally about 5-10 layers, and a height sufficient to not only serve as functional electrodes, but also as the supporting walls of the micro-channel, for example, 25, 35, or more micrometers. For some embodiments, an optional spacer, e.g., formed of an adhesive, can be used to add further dimension to the micro-channel, preferably added by screen printing layers

In an embodiment, the microfluidic devices of the invention include at least one pair of opposing 3-dimensional structures applied to a substrate by thick film printing, such as screen printing. The opposing ink deposit structures form parallel walls of a micro-channel, where the substrate forms the floor and a cover is disposed atop and between the opposing ink deposit walls. Each of the walls comprises multiple layers of deposited ink, which may be of the same or different composition, geometry, or footprint. Multiple pairs of opposing 3-D ink deposit structures can be aligned in series along the length of the micro-channel to form a multi-functional micro-channel. In an alternative embodiment, multiple functions can be created in the 3-D ink deposit structures by applying layers of ink having different compositions to form the 3-D ink deposit structure.

The opposing surface of one or both opposing 3-D ink deposit structures can be functionalized, for example by applying a chemical, biological, or other useful material to the surface of the ink deposit structure. The surface may be functionalized, for example, by electro-polymerization of a conductive polymer within the micro-channel, by electrophoretic deposition of materials or pin or ink jet deposition of inks modified to contain the desired materials. Such materials, include, for example, colloidal particles, analytes, enzymes, antibodies, cells, proteins, and the like.

The ink used to screen print 3-D elements can contain a variety of elements, for example, conductive, catalytic, biologic, and/or dielectric materials. The ink can be a a conducting ink useful in generating electrodes, for example working electrodes and reference electrodes, for example, formed of silver, sliver chloride, carbon, gold, platinum, copper, and other such known electrode-forming inks. Preferably, the ink comprises an electrode material suitable for a desired function in the micro-fluidic device. In an embodiment, the working electrode and the reference electrode are printed on a substrate, for example by screen printing, and in a plurality of layers to form opposing walls of a micro-channel. The micro-channel may be functionalized, for example, include a functionalized polymer, for example, a conductive polymer such as a polyaniline, or other components useful in micro-reactions or other unit operations such as separation, adsorption, extraction, and the like.

In an embodiment, the ink deposit structures, which can be identical or different in composition, geometry, and/or footprint, can be aligned in series to oppose each other along the length of the micro-channel or aligned vertically along the height of the micro-channel. When the ink deposit structures comprise conductive materials, e.g., electrodes, dielectric materials may be deposited between members of the series and/or between layers of the ink deposits.

The microfluidic devices described herein can be adapted for immobilizing chemical and biological agents useful in analytical reactions, and can be fabricated for analysis of chemical and biological agents, for example analytes, microorganisms, proteins, and the like present in a sample.

### DETAILED DESCRIPTION OF THE INVENTION

### Definitions

A “microfluidic device” is a device for manipulating fluids within a geometrically constrained space at a sub-millimeter scale. Microfluidic devices include, for example, microsystems, microreactors, labs-on-a-chip, biochips, DNA chips, microarrays, biosensors, and the like.

A “substrate” is any suitable surface on which layers of ink can be deposited using thick film printing or screen printing, and includes, for example, plastics such as polyester and the like, paper, paperboard, glass, ceramics, metals, fabrics, and the like.

A “functionalized” surface is a surface which has been modified by, for example, screen printing, coating, deposition, pin or ink jet deposition, electrophoretic deposition, polymerization, and the like, such that it acquires a new function or an enhanced function. A new or enhanced function may include, for example, conductivity, catalytic activity, enzymatic amplification of an electrochemical signal, and the like. Methods that can be used to add functional components to the electrodes included, for example, electropolymerization of a conductive polymer, electrophoretic deposition of colloidal particles, or electrophoretic deposition of biological elements selected from enzymes, antibodies or single stranded (ss) DNA.

A “conductive polymer” is an organic polymer capable of electronically or ionically conducting an electrical current and includes, by way of example, polyanilines, polythiophenes, polypyrroles, polyacetylenes, poly(p-phenylene) sulfides, poly(para-phenylene) vinylenes, and the like.

A “colloidal particle” is a particle of about 10⁻⁹ to about 10⁻⁵ meters in diameter, and having an obvious phase boundary with respect to the substance in which it is dispersed.

“Analyte” as used herein, is meant to include substances that may be analyzed, immobilized, detected, and the like, in the microfluidic devices described herein. Such analytes include, proteins, allergens, metabolites, sugars, lipids, pathogenic microorganisms and viruses, DNA, RNA, hormones, and the like.

A “biological element” is a biological macromolecule having a biologic function including, for example, proteins, enzymes, antibodies, DNA, ssDNA, RNA, ssRNA, microRNA, ribozymes, and the like.

Screen-printing is a lower resolution thick film technology that can be applied to plastic substrates as well as glass, fabrics, or silicon. This technique has been used mainly in the microelectronics industry for fabrication of printed circuit boards in two dimensions, but also in the clothing industry for 2-D pattern impression on fabrics. In order for screen printing to be used as a microsystem fabrication technique, the 3-D nature of the ink deposit must be realized. Using a layer-by-layer 3-D element fabrication method, the flexibility of the technique lies in that almost any substrate can be used, in the possibility of printing with different commercially available inks that can be functionalized by adding specified catalysts or enzymes, and in the possibility of printing different layers with various inks, allowing an unlimited variety of designs and for the incorporation of active elements. These advantages, as well as the low cost and fast prototyping cycle, make screen printing ideal as a manufacturing approach for micro-fluidic elements.

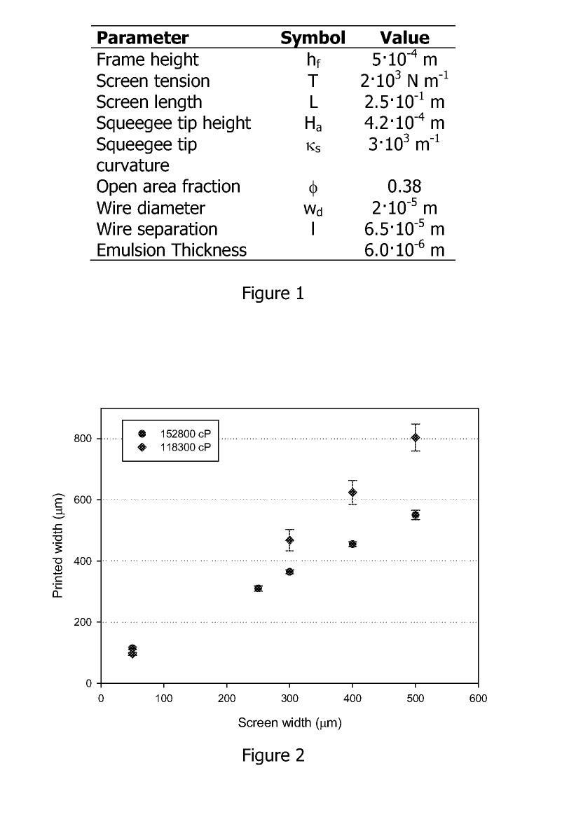

Screen-printing is already used in fields such as clinical, environmental or industrial analysis [4], and in fuel [5] and solar cells [6]. The use of screen-printing techniques in the biosensors manufacturing area has resulted in micro-fluidic devices based on the production of micro-channels combined with electrodes [11]. These devices show a similar architectural concept to the one presented in this work but with a difference: the reported micro-fluidic device is composed of well-differentiated structural parts (fluidics) and functional parts (electrodes). In contrast, to further simplify micro-device fabrication as described herein, the structural and functional elements are combined in a single element, for example, making the fluidics part be also electrochemically active, as depicted in FIG. 1. In addition, the influence of some screen printing process tunable variables on the principal characteristics of micro-system components (definition, resolution, and thickness or aspect ratio) adds to the utility of the micro-fluidic devices described herein.

Exemplary screen-printed micro-channels were built, and the functionality characterized using confocal microscopy to visualize the occurrence of electrochemical processes within the micro-channel. In one example, the micro-channel was modified electrochemically through generation of a polyaniline conductive polymer layer and supraparamagnetic beads in spatially defined positions, thereby allowing for the in-situ multifunctional modification of the microsystem.

Electro-polymerization is an efficient enzyme immobilisation method used in biosensor development [13]. Conducting polymers such as polythiophene, polyaniline, polyindole and polypyrrole can be grown electrochemically on an electrode surface. The thickness of the growing polymer film can be controlled by measuring the charge transferred during the electrochemical polymerisation process [14]. An advantage of having an electrode covered by a layer of a conducting film is that it can entrap active agents such as enzymes and the like, for example, if they are electro-polymerized together with the conducting polymer. Alternatively, if the polymer is already in place, the enzyme or other active agent can be adsorbed by electrostatic charges. The spatial distribution of the immobilized enzyme is controllable [14]. The polymer layer can act as a transducer and/or a platform to immobilize an active agent, for example a recognition element in a reactive layer in a manner that is applicable to biosensor design. In the case of paramagnetic particles, electrophoretic deposition can be used, wherein colloidal particles suspended in a liquid medium migrate under the influence of an electric field and are deposited onto an electrode [15-17].

### Substrate

In the examples below, the substrate on which the films were printed is a polyester film with a thickness of 175 μm provided by Cadillac Plastic S.A. (Spain). Many such substrates are known and can be used in the micro-fluidic devices described herein. The substrate is cut according to a desired design to be printed.

### Inks

Conductive inks useful in the devices and methods described herein, may include metallic particles, for example, gold, silver, silver chloride, copper, and the like, or carbon. In the Examples below, electrodes were formed using 7102 CONDUCTOR PASTE based on carbon and 5874 CONDUCTOR PASTE based on Ag/AgCl, with a specific thinner to decrease the viscosity (3610 THINNER), provided by DuPont Ltd. (UK). Electrodes used in the microfluidic devices described herein comprise, for example, carbon, silver, silver chloride, gold, copper, platinum, or a combination thereof. Materials useful as electrodes may combined with a solvent, binder, or other materials and used as an ink in screen printing methods.

### Screens

Screens are designed to provide the desired geometry and placement of the three dimensional printed elements on the substrate. For the Examples below, screens were designed in house and manufactured by DEK International (France). Three different screens with different specification parameters were used: (1) to perform the line resolution test a stainless steel mesh 300 SDS (65/20), having an emulsion thickness of 6.0·10⁻⁶ m was used; (2) to perform the resolution test of microchannels a polyester mesh 380 (150/27) was used; and (3) to carry out the microchannel fabrication by optical alignment a stainless steel mesh 200 (90/40) was used. The screens are specified mainly by the material of the strands used, the strands per inch (mesh), the opening between the strands and the wire diameter.

### Micro-Channels

Micro-channels formed between opposing walls of multi-layered ink deposit structures can vary in height, width, and thickness, depending on the properties of the ink(s) used, the number and thickness of the layers applied, and the desired composition, geometry, footprint, and function. In general, the width of the micro-channel may be about 50, 100, or greater micrometers, although micro-channels of smaller widths are also useful. The thickness of each wall may be about 4 micrometers or more, for example. The height of the micro-channel may be about 25, 35, or more micrometers, for example.

The squeegee used in the Examples below was made of polyurethane and provided by DEK International (model SQA152 with a contact angle of 45° and a hardness factor of 70). The adhesive used to close the micro-channel was a commercial Arcare 90485 provided by Adhesives Research Inc (UK). It is a PET tape, coated with acrylic medical grade adhesive on both sides with a total thickness of 254 μm. Other such materials are known and can be used to form the microfluidic devices described herein.

Poly(vinylsulfonic acid) aniline and fluorescein were provided by Sigma-Aldrich (Spain), hydrochloric acid 1 M, di-sodium hydrogen phosphate and sodium dihydrogen phosphate provided by Scharlau (Spain) and Dynabead M-270 Epoxy beads provided by Invitrogen (Norway).

The screen-printing apparatus was a DEK-248 (DEK International). The machine has a DEK Align 4 Vision System Module that is a 2-point optical alignment system. The screen used was a 300 SDS (65/20) (DEK International)

The printing temperature was fixed to 22° C. The curing of the ink is performed in the oven at 120° C. for 10 minutes. The separation speed of the substrate is adjusted to 2·10⁻³ m/s.

The viscosity of the inks was determined with a Brookfield DV-E Viscosimeter equipped with a Small Sample Adapter and a SC4-21 spindle (Brookfield, UK).

The profilometries were performed with a Mitutoyo SJ-301 profilometer, and the data obtained was analyzed with the software SURFPAK-SJ Version 1.401 (Mitutoyo Messgeräte GmbH, Japan). The curing of the ink was carried out in a Digiheat 150L oven (JP Selecta S.A, Spain).

### EXAMPLES

The invention is described by the embodiments below, which are of an exemplary nature. It is to be understood, however, that other modifications can be made without departing from the spirit and scope of the invention as claimed.

### Example 1

### Fabrication and Optimisation of a Screen Printed Microsystem

This work was carried out to produce a screen printed microsystem platform and explored different fabrication conditions and parameters.

### Maximum Line Resolution

The objective of this study was to establish that screen printing can be used to transfer 3-D patterns capable of forming microfluidic elements onto a substrate and to fine-tune process parameters that can optimise the 3-D transfer. A large number of process parameters have been identified that affect to a greater or lesser extent the architecture, geometry and appearance of the designs produced [18]. Kobs and Voigt performed a parametric experimental evaluation of 50 variables and compared the results on the basis of a “rating system” based on image analysis primarily and only supported by resistance and profilometry of the patterns. Although their work is the first published systematic approach to the screen printed process, it is only of marginal help for the purposes of the present study. Still, it helped identify a subset of important process parameters.

Much more valid insight could be obtained from theoretical analysis and modeling of the process, in order to verify a predictable effect on the printed pattern. Off-contact screen printing is essentially the passing of a non-Newtonian fluid through a barrier under the pressure exerted by the squeegee. As the squeegee moves, the screen is deformed, the ink passes through the barrier, and after the pass of the squeegee the screen returns to its initial position. Several attempts have been reported in the literature to model this process [19-28]. Of these attempts Riemer's [19-21] represent the earliest reports in the literature modeling the process along the scraper model of Taylor [29]. This effort was extended to include non-Newtonian fluids [22] and the gap between the substrate and the screen [23]. These models are not easily exploited for the purposes of this work because they lack the detail necessary for taking into account the geometry of the squeegee attack or the screen permeability and deflection, all of which should be taken into account when optimizing the 3-D transfer of patterns. In addition, they are solved for the pressure exerted by the squeegee, a variable with little value for evaluation of the print result. Subsequent attempts have used lubrication theory for the flow of ink through the screen [24,25] but have still failed to account for the geometry of the process, whereas a more complete solution (including non-Newtonian behaviour) is limited to the simpler stencil process [26].

Another characteristic that most models fail to address consistently is the existence of the hydrodynamic film under the squeegee during its pass over the screen. Most models account for it in order to achieve continuity of the mathematical solution, but experience shows that this is not the case. Finally, the quantification of the ink left on the substrate, an important parameter, was only undertaken directly in one work [27]. However, the model in this reported work was solved numerically and does not provide a clear insight into the process. The squeegee geometry (roller type) was also different than the one used in this work. Recently, [28] another study provided a solution for the flux of ink through the screen, and although it does so only for Newtonian fluids, it establishes some dimensionless numbers that could be used at least for a first approximation in assigning importance to process parameters. White et al. [28] conclude that, other parameters kept constant, it is the magnitude of (L/h_{f})(κₛHₐ)^{0.5} (L is the screen length, h_{f} the frame height, κₛ the squeegee tip curvature, and Hₐ the squeegee tip height) that controls the flux of ink through the screen, whereas Fox et al. [27] ascertain that the deposited thickness is directly proportional to this flux modulated only by the mesh ruling and the screen open area. Knowing that screen characteristics and squeegee geometric parameters are important for ink flow and therefore 3-D transfer of patterns, it was decided in this first approximation of parametric evaluation to vary only the parameters directly related to the screen-printing process.

The parameters considered that may have greater effect on the final product quality are the pressure of the squeegee (P), the speed of the squeegee over the screen (S) and the print gap between the substrate and the screen (G). Preliminary work was also undertaken to determine if the viscosity significantly affects the quality of the print, although it is intuitively obvious that this “raw material” property will be of primary importance for further optimisations. However, the present study focuses on process parameters rather than on raw material properties. As a result, the screen characteristics (tension, length, void area, etc) and the squeegee angle of attack and geometry were fixed as indicated in Table 1.

The evaluation was performed against three properties of the print: once the designs were cooled, the resistance(R) of the printed figure was measured with a two point probe. The ink was made of carbon and was electrically conductive. The measurement of the resistance provided preliminary information about the quality of the printing. Optimum values of up to 500 ohms were considered valid, based upon practical experience showing that this level of resistance still ensures good electrochemical responses of the material. Secondly, the thickness (δ) of the ink deposited was measured with the profilometer. This data provides information about the uniformity of the ink deposited and the roughness of the surface (this is roughly the aspect ratio that can be achieved per pass). Finally, a characteristic distance of the design (which is here referred to as resolution) was measured. In the case of printed lines, this characteristic distance was the width of the thinnest printable line (a characteristic of the print process) and in the case of the microchannels, it was the width of the micro channel (a characteristic of alignment).

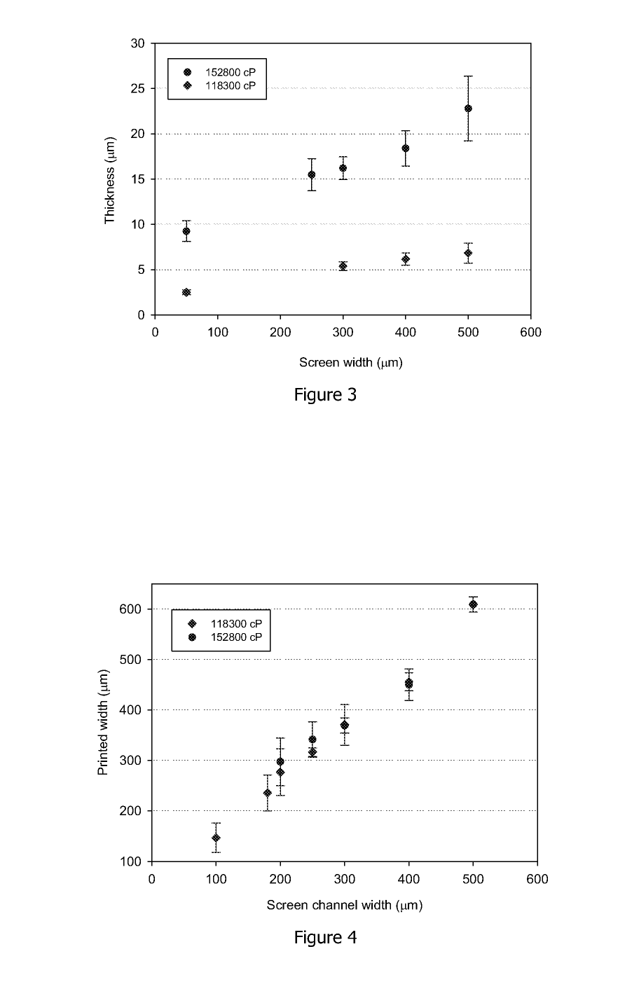

Raw material properties were used only as an indicator of possible process improvements. In order to examine the effect of ink viscosity on the print and establish the repeatability of the process, two inks were prepared with viscosities of 152800 and 118300 cP, and a series of 40 substrates were printed with the fixed process parameters predicted for highest resolution. The results are summarised in FIGS. 2 and 3.

Observation of the results indicates that a lower viscosity ink permitted printing of lines with a lower width and smaller designs despite the fact that the print spreads more. On the other hand, the thickness achieved was smaller with lower viscosity. Both results were expected from intuition and the modeling efforts mentioned above. Also of importance is the fact that repeatability is better when thinner line patterns are transferred, and it also improves with the higher viscosity ink. Overall, it appears that tuning of the viscosity of the inks used is an important parameter to control in order to achieve high resolution and reproducible results.

### Maximum Micro-Channel Resolution

In order to determine the capacity to print microchannels, a screen was used with microchannel designs of different widths between lines. A polyester screen with a larger space between strands was used because the tension during the separation of the substrate and the mesh was so high that the screen could break.

The same experimental design as before was applied. The resolution reported was the width of the printed microchannel as measured by acquiring a transversal profilometry of the entire figure printed, and reporting the peak of the profile on both sides of the channel. Obviously, the real width of the printed channel is smaller since the ink printed forms a sloping deposit that peaks approximately in the middle of the wall width. Efforts to quantify the slope of the deposit are in progress since it is another quality characteristic in 3-D ink transfer for microsystem production. The resistance was measured between the extreme points of the transferred design. The thickness corresponds to the ink printed. In this case the thickness of the ink was the thickness of the walls of the micro channel, and again, was reported as the maximum thickness of the deposit.

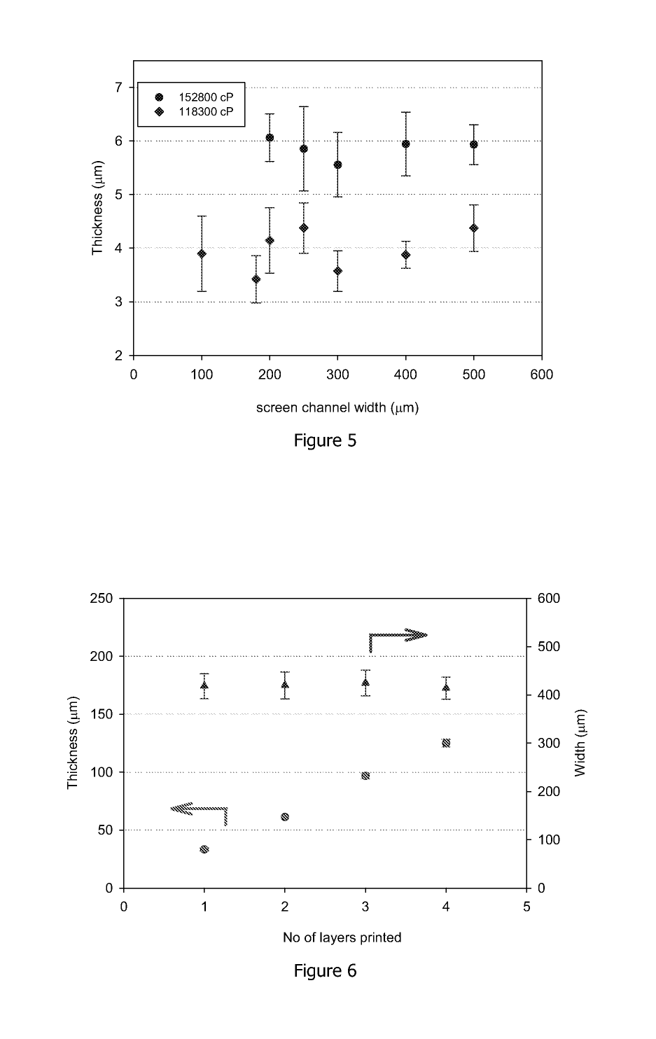

In order to examine the effect of ink viscosity on the print and establish the repeatability of the process, two inks were prepared with viscosities 152800 and 118300 cP and a series of 6 substrates were printed with the process parameters fixed as predicted from the model for highest resolution. The results are summarised in FIGS. 4 and 5.

Observation of the results shows that, as was expected, the channel width does not influence the thickness of the deposition, which also had the expected behaviour as a function of ink viscosity. The repeatability of the process was not as much a function of dimensions as before. The lower viscosity ink allowed for the printing of finer channels, the minimum width being 146±3 μm with a wall thickness of 3.90±0.66 μm. It was also noticed that lower viscosity resulted in the accumulation of ink in the back of the screen, so that when printing microchannels, lower print gaps may be used to avoid this leakage. The use of higher pressures can also improve print quality.

Micro-Channel Fabrication with Optical Alignment

The thickness achieved when printing the microchannel directly from a screen design is small, and to obtain a higher thickness it is necessary to print several layers. To increase the thickness printed, a screen with higher separation between wires can be used, but at the expense of resolution. In addition, it is of interest to print different materials in different parts of the microfluidic device. For these reasons, a multistep process was developed where different screens with different designs are aligned over the substrate. To achieve this alignment, the Align Vision System Module of the screen-printing equipment was used. This alignment module has micrometric precision and uses two reference points that can be incorporated in the screen design.

A series of exploratory experiments were designed to determine a minimum width achievable when printing several layers of ink to increase thickness while maintaining the width, given the optical alignment and accuracy of the equipment. A desired width is fixed manually in the equipment. The print gap used was 0.9 mm, the pressure was 3.08·10⁴ Pa and the squeegee speed was 64 mm/s. Three different separation settings were tested until optimum conditions were determined. In these experiments, the best micro-channel obtained had a thickness of 18.86±4.41 μm and a width of 198±60 μm. The printing of several layers was performed using this optimum equipment separation.

The results obtained after printing four layers (FIG. 6) show that the thickness increases gradually when the number of layers printed increases, while we were able to maintain the channel width within acceptable limits. The effect of multilayer printing was that the walls of the micro-channel do not remain vertical and tend to slope outwards having the channel a higher width in the upper than in the lower part. It was therefore concluded that it is feasible to align the screens in order to print different materials in the microfluidic device, and the multilayer printing can achieve a big variety of aspect ratios.

### Example 2

### Example of a Functional Screen Printed Microchannel

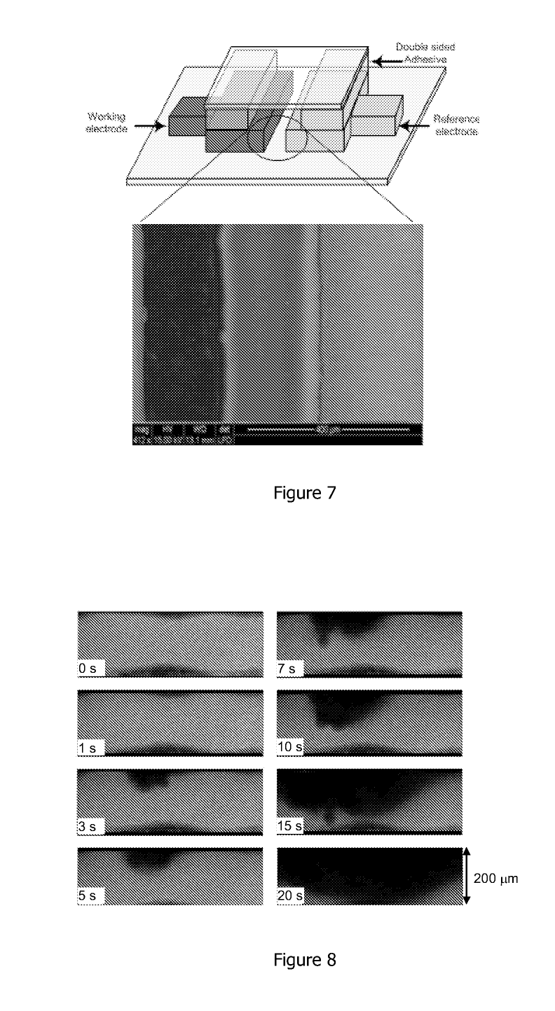

After it had been shown that microchannels could be fabricated, a demonstration of a functional screen-printed microchannel was produced, having an approximate width of 200 μm and thickness of 25 μm. For demonstration purposes, a microchannel was constructed with carbon ink as one wall (working electrode) and Ag/AgCl ink as the opposite (counter/reference electrode). A micro-electrochemical cell was thus produced. A plastic substrate layer coated with adhesive on both sides was used to manually seal the top of the microchannel. See FIG. 7.

### Optical Monitoring of Electrochemical Reaction in the Micro-Channel

A screen printed micro-channel fabricated according to Example 1 was filled with 0.1 M fluorescein, and a voltage of 2 V was applied across the 200 μm distance between the electrodes, creating a water electrolysis that generated a change of pH and hence an accumulation of protons in the proximity of the electrode. This induced pH change makes the fluorescein change colour, and this was monitored by confocal microscopy. As observed in the confocal microscopy image, FIG. 8, the reaction takes place specifically in the working electrode (top of the confocal image) and the diffusion of the reaction products within the micro-channel was clearly observable.

### Deposition of Polvaniline and Superparamagnetic Beads in Micro-Channels

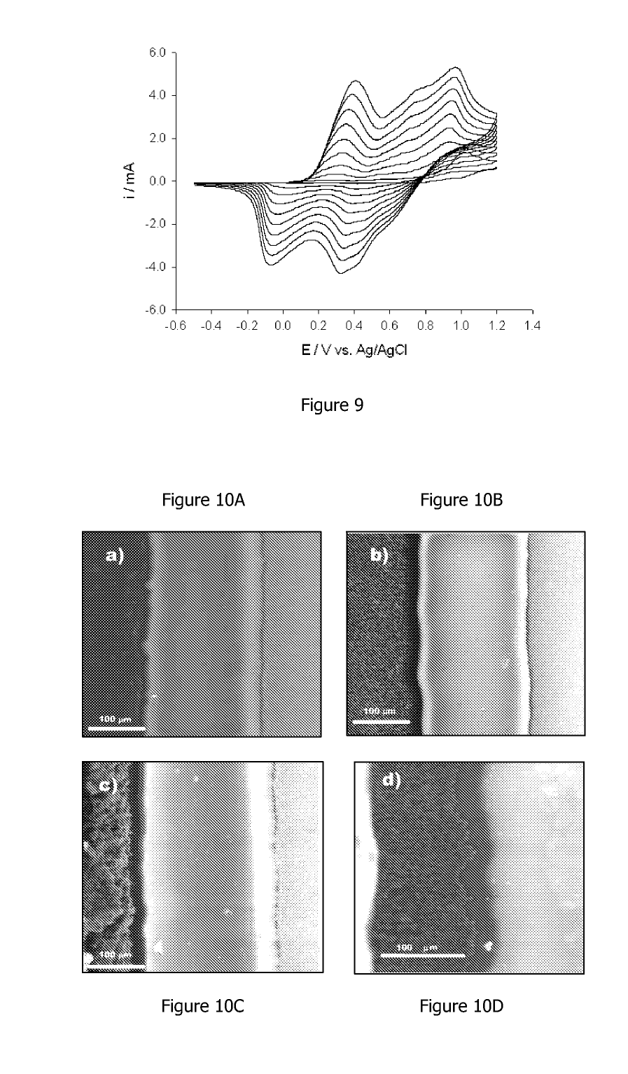

This example involved the electro-polymerization of a conductive polymer (poly(aniline)), and the electrophoretic deposition of paramagnetic particles on the channel wall, both processes that can only be realised if functional electrodes are incorporated into the microchannel. The total thickness was 254 μm to simulate the walls of the microchannel. Once a single-layer microchannel was printed and closed a different number of cycles (2, 5, 10, and 20) the microchannels were tested by microscopy and cyclic voltammetry to verify the growth of the polyaniline layer on the working electrode. FIG. 9. Cyclic voltammetry showed the characteristic poly(aniline) peaks, while the microscopy results are shown in FIG. 10a-c. With two cycles, no polyaniline deposition was observed, whereas after five cycles the deposition became discernible. The increase of the amount of polymer deposited on the electrode can be observed comparing the results after 20 cycles.

The immobilisation of paramagnetic particles inside the microchannels was observed in the ESEM. The particles can be seen electrophoretically deposited on the working electrode, demonstrating the functionality of the microfluidic element for selective deposition, FIG. 10d.

### Example 3

### Immobilisation and Monitoring of Pathogens within a Screen Printed Microchannel Via Impedance Measurements

Maintaining the bacteria as close as possible to the active layer of the electrode eliminates any mass-transfer limitations, and ensures fast responses of the electrodes. In some cases the use of very little volumes, in the nanoliter range [30], eliminated the necessity of immobilizing the bacteria near the electrode surface. Applying a potential of opposite sign and enough intensity on the electrode surface should ensure the irreversible immobilization of paramagnetic immunoparticles inside the microchannel on the electrode surface. The investigations carried out showed an immunoparticle zeta-potential of −12 mV; therefore a positive potential was applied. It was found that applied potentials of 1 V were enough to ensure the immobilization of the immunoparticles without compromising the stability of polyaniline films, which seemed “permeable” to the applied potential, and did not significantly hinder immunoparticle immobilization or electrochemical currents on the electrode surface.

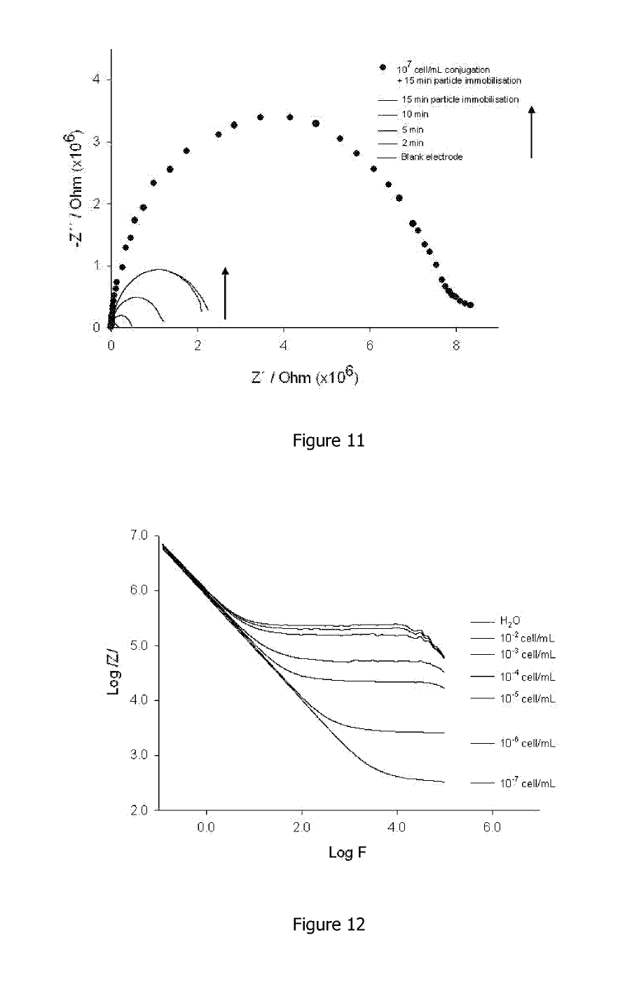

The electrophoretic deposition of the immunoparticles was investigated by impedimetric methods. As can be seen in FIG. 11, the electrophoretic deposition potential for different times, and the presence or absence of bacteria conjugated with the immunoparticles, could be monitored impedimetrically.

The efficiency of the electrophoretic deposition was evaluated, and times of 15 minutes were considered enough to achieve a maximum deposition according to the impedances measured for each time.

It was observed that the presence of bacteria conjugated to the immunoparticles greatly increased the impedance measured at the electrode when compared to a bare electrode or to an electrode with bare immunoparticles. These large impedimetric signals confirm the successful immobilization of bacteria near the electrode surface by means of the immunoparticles.

### Example 4

### In Situ Monitoring of Cell Lysing and Quantification of Pathogen Load

The lysis of the bacteria introduced inside the microsystem was accomplished by incorporating the components of the lysing mixture (20% polyethylene glycol, 20% polystyrene and 2% polymixin B (wt %) in PBS) into the channel by impregnating the inner surface top cover of the microfluidic device with the lysing mixture. Experiments outside the micro-channel showed that such mixture should achieve total lysis of the bacteria load in approximately 15 minutes. The efficiency of the lysis step was checked by non-faradaic impedimetric methods. The solution used to carry out the impedance measurements was milliQ water, with no addition of extra supporting electrolyte or electrochemical redox couple. The equilibrium potential then was set as the open circuit potential of the electrode in contact with such solution. First the efficient lysis inside the channel was checked with free bacteria injected inside the microchannel and left in contact with the lysing material for 15 minutes. Then non-faradaic impedimetric measurements were carried out for solutions having different bacteria concentrations. As the presence of lysed bacteria in the media increased due to the release of intracellular components, with salts and ions among them, the resistivity of the media decreased, see FIG. 12. This effect of the changing resistivity of the media with different concentrations of lysed bacteria (10²-10⁸ cells/mL) was more easily appreciated for frequencies between 10⁵ and 10⁴ Hz where all signal were stabilized.

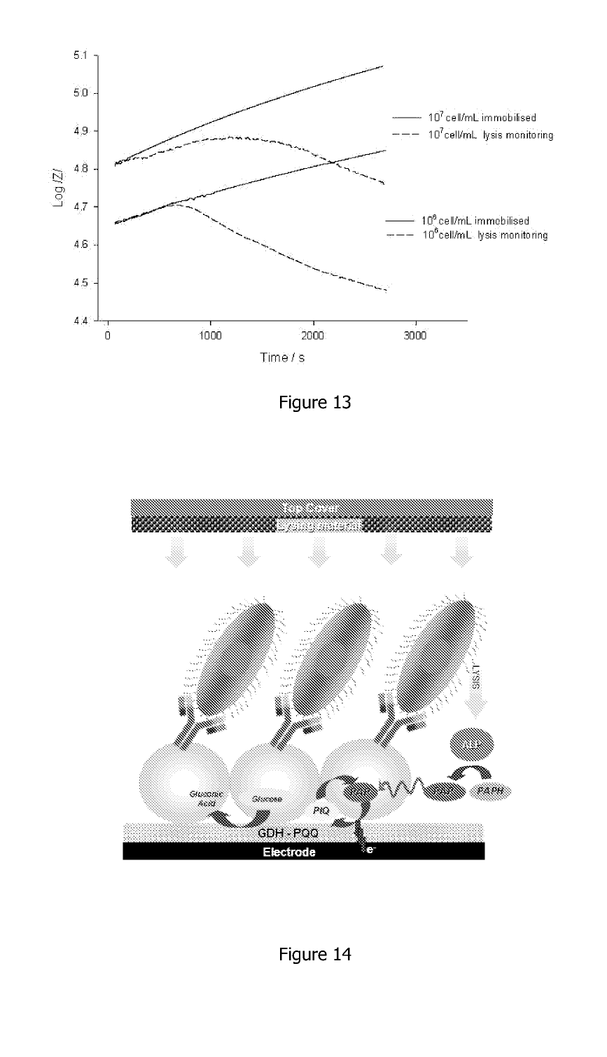

This non-faradaic impedimetric measurement confirmed the efficiency of the inside-the-microchannel lysis, and also constituted an alternative method for detecting high concentration of cells via in-situ lysis and measurement. In order to increase the accuracy of the method and to be able to more closely monitor the lysis in real time, the next impedimetric measurements were faradaic ones, see FIG. 13. The bacteria were immobilized on the electrode surface via electrophoretic deposition of the immunoparticles as described above. Real time monitoring of the lysis was performed and compared against a blank where no lysing agent was present in the microchannel. The results showed it was possible to monitor and distinguish the cell lysis near the electrode. The times beyond which the change in impedance became noticeable coincided with the approximately 15 minute full-lysis times as measured on culture plates

### Example 5

### Amperometric Detection of Pathogens within the Microsystem

The determination of pathogenic load using Salmonella as a typical example of real targeted bacteria for detection has been explored [31,32], and its detection has been attempted by electrical and electrochemical impedance as well as by more standard amperometric methods, including detecting the intracellular alkaline phosphatase by the enzymatic conversion of p-aminophenol [33,34].

The electrochemical-detection-based microsystem depicted in FIG. 14 was built, and different loads of pathogen were exposed to the immunoparticles that later were immobilized [35] in the inside of the microchannel containing the lysing mixture that liberated the intracellular components. The presence of alkaline phosphatase (ALP) acted as catalyst for the in-situ generation of p-aminophenol (PAP) from the injected ALP substrate p-aminophenol phosphate (PAPh). The generated PAP was oxidized on the electrode surface, producing p-iminoquinone (PIQ) by exchanging two electrons. The immobilized GDH-PQQ reverted the PIQ back into PAP that was again oxidized on the electrode surface, creating an enzymatic amplification cycle that generated a discernable amperometric signal. Different pathogen loads were exposed to the immunoparticles solution and injected into the microchannel; after the electrophoretic deposition the supernatant in the microchannel was replaced by a solution containing both the substrates for GDH-PQQ and ALP in 0.1. M PBS.

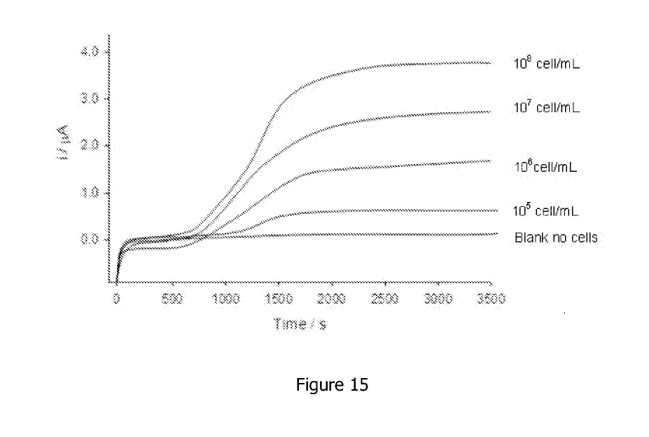

As can be seen in FIG. 15, the amperometric response observed from the microchannel was proportional to the concentration of pathogens primarily exposed to the immunoparticles, and such response appeared again near the 15 minutes that the lysing agent was estimated to take to liberate the intracellular alkaline phosphatase.

### Example 6

### Production of a Functional Screen Printed Micro-Channel

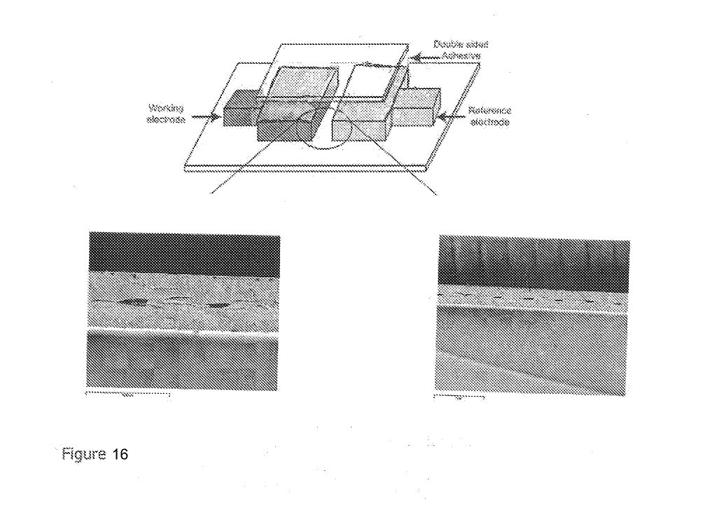

In the same manner as described above for Example 2, a functional screen-printed micro-channel was produced, having an approximate width of 200 μm and thickness of 25 μm. For demonstration purposes, the micro-channel was constructed with carbon ink as one wall (working electrode) and also carbon ink as the opposite (counter/reference electrode). A plastic cover was applied to extend from and between the electrode walls to cover the micro-channel. No substrate was used to extend the walls of the micro-channel. See FIG. 16.

### Example 7

### Example of a Multi-Functional Screen Printed Micro-Channel

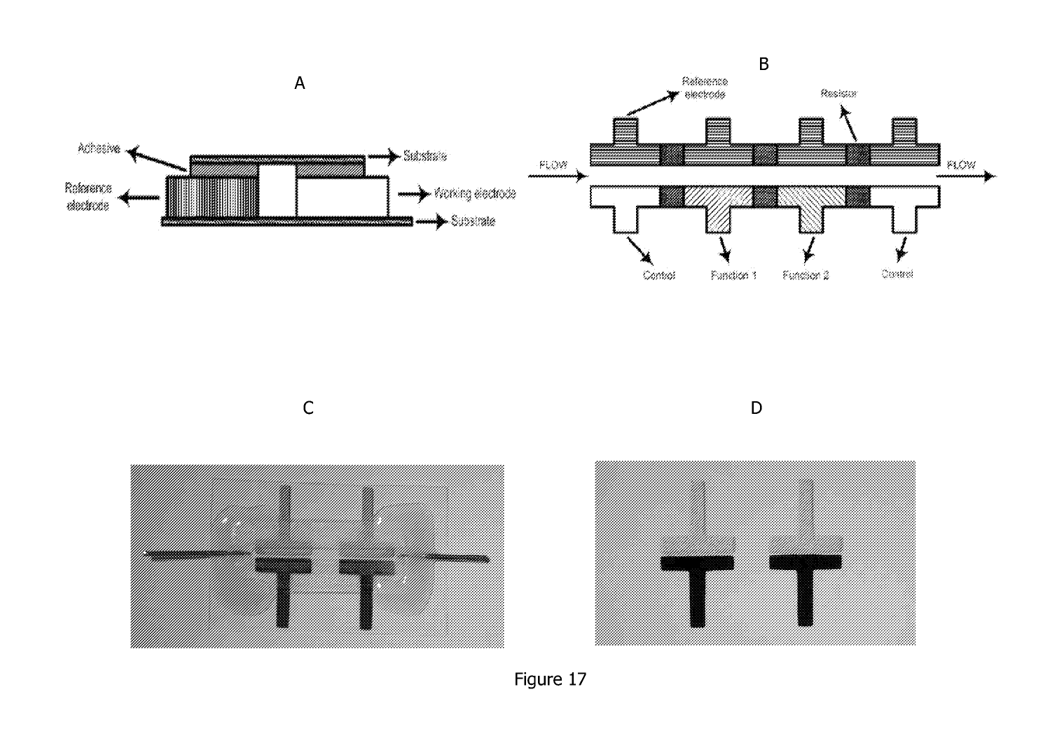

In the same manner as described for Example 2, a multi-functional screen-printed micro-channel was produced. In the multi-functional micro-channel independent or serial/parallel functions can be performed. For example, in the case of lab on a chip systems, the possibility to perform control or multiple measurements is introduced. For demonstration purposes, a serial two-function micro-channel was constructed with carbon ink as one wall (working electrode) and Ag/AgCl ink as the opposite wall (counter/reference electrode). A plastic substrate layer coated with adhesive on both sides was used to manually seal the top of the micro-channel. The joint between adhesive and the ink was sealed in order to fix the fluidic system. See FIG. 17.

### REFERENCES

[1] Doku et al., 2005 Tetrahedron 61:2733-42.
[2] Weigla et al., 2003 Adv. Drug Deliv. Rev. 55:349-77
[3] Jakeway et al., 2000 Fresenius J. Anal. Chem. 366:525-39
[4] Albareda-Sirvent et al., 2000 Sens. Actuator B-Chem. 69:53-63
[5] Viricelle V 2006 Sens. Actuator B-Chem. 118:263-68
[6] Krebs et al., 2007 Mater. Sci. Eng. B-Solid State Mater. Adv. Tech. 138:06-11
[7] US 2005 0 204 939
[8] US 2003 0 046 811
[9] US 2002 6 440 645
[10] U.S. Pat. No. 6,939,451
[11] Dong et al., 1996 Microelectronics International 13(2):9-12
[13] Iwuoha et al., 1997 Biosens. Bioelectron. 12 (8) 749-61
[14] Killard et al., 1999 Anal. Chim. Acta 400 109-19
[15] Kanamura K and Hamagami J 2004 Sol. St. Ion. 172 303-8
[16] Campàs M and Katakis I 2004 Int. J. Env. Anal. Chem. 84 (11) 799-807
[17] 2003 WO Pat. 062 456
[18] Kobs D R and Voigt D R 1970 Proc. ISHM 18 1-10
[19] Riemer D E 1988 Sol. St. Tech. 8 107-11
[20] Riemer D E 1988 Sol. St. Tech. 9 85-90
[21] Riemer D E 1989 Hybrid Circuits 18 8-17
[22] Huner B 1994 Int. J. Microcircuits and Electronic Packaging 17 21-6
[23] Jeong J and Kim M 1985 J. Phys. Soc. Jpn. 54 1789-99
[24] Owczarek et al., 1990 IEEE Trans. Compon. Hybrids Manuf. Techl. 13:368-75
[25] Anderson et al., 2000 J. Prepress & Printing Technology 3:10-16
[26] Glinski et al., 2001 Proc. Inst. Mech. Eng. 215 (4): 437-46
[27] Fox et al., 2003 Proc. Inst. Mech. Eng. 217:345-59
[28] White et al., 2006 J. Eng. Math. 54:49-70
[29] Taylor, 1962 Miszellaneen der Angewandten Mechanik 313-5
[30] Varshney et al., 2007 Sens. Actuator B-Chem 128(1):99-107
[31] Yang et al., 2003 Biosens Bioelectron, 19(5) 495-502.
[32] Yang et al., 2006 J. Microb. Methods, 64(1):9-16
[33] Boyaci et al., 2005 Anal Bioanal Chem, 382(5):1234-1241
[34] Astier et al., 2004 Bioelectrochem, 64(1):53-59
[35] Dondapati et al., 2008 Biosens Bioelectron, 24(1):55-9

1. A micro fluidic device comprising:
a) a substrate;
b) an opposed pair of thick-film printed ink deposits so as to define a functional and structural channel whose depth is determined by the thickness of said ink deposits on the substrate comprising:
b1) a first ink deposit structure comprising a plurality of layers deposited on the substrate by screen printing;
b.2) a second ink deposit structure comprising a plurality of layers deposited on the substrate by screen printing and positioned to oppose said first ink deposit structure;
c) a second and subsequent pairs of ink deposits as described in b) aligned to oppose each other and along the length of the previous deposits so as to form an extension of said channel; and
d) a cover;
wherein said substrate, first and second ink deposit structures, and cover form a three dimensional micro-channel defined between said opposing ink deposit structures, said substrate, and said cover disposed atop said first and second ink deposit structures.

2. The device of claim 1, wherein one or both ink deposit structures of one or more structure pairs comprises conductive ink and forms one or more electrodes.

3. The device of claim 1, wherein an opposing surface of said first ink deposit structure, said second ink deposit structure, or both ink deposit structures of one or more structure pairs are functionalized by:
a) electropolymerization of a conductive polymer; or
b) electrophoretic deposition of colloidal particles; or
c) electrophoretic deposition of biological elements or catalysts;
d) pin or ink jet deposition of polymers, particles, biological elements, or catalysts.

4. The device of claim 1, wherein said first or said second ink deposit structure of one or more structure pairs independently comprises particles of carbon, silver, silver chloride, copper, platinum, gold, a modified ink containing conductive, catalytic, or biological elements, a dielectric, or a combination thereof.

5. The device of claim 1, wherein:
a) the width of said micro-channel is about 50, 100, or more micrometers; or
b) the thickness of each of said first and said second ink deposit structure and structure pairs is about 4-7 micrometers or more; or
c) the height of said micro-channel is about 25, 35, or more micrometers.

6. The device of claim 1, wherein said structure pairs comprises one or more member that differs from another pair in geometry and/or footprint.

7. The device of claim 6, wherein said pairs comprise series of electrodes, and optionally include dielectric ink deposits between electrodes in the series.

8. The device of claim 6, wherein each layer of the plurality of layers forming said first and said second ink deposit structure comprises an ink composition, and wherein a pattern of layered ink compositions forming each first and second ink deposit structure is identically repeated in the electrodes of said first and second series.

9. The device of claim 1, wherein one or more individual layers of the plurality of layers forming said first ink deposit structure or said second ink deposit structure differs in composition from other layers in the ink deposit structure.

10. The device of claim 1, wherein said plurality of layers is deposited on the substrate using screens having two or more differing screen patterns.

11. The device of claim 1, wherein said ink deposit structures are electrodes configured to conduct electrochemical measurements or to immobilize a substance.

12. The device of claim 1, wherein said ink deposit structures are electrodes configured to immobilize a biological element.

13. The device of claim 1, wherein said ink deposit structures are electrodes configured to determine the concentration of an analyte in a sample.

14. The device of claim 1, wherein said plurality of layers is at least 5 layers.

15. The microfluidic device of claim 1, wherein said plurality of layers is 5, 6, 7, 8, 9, 10, 11, or 12 layers.

16. A method of making the microfluidic device of claim 1, comprising:
a) an opposed pair of thick-film printed ink deposits so as to define a functional and structural channel whose depth is determined by the thickness of said ink deposits on the substrate comprising:
a.1) depositing a plurality of layers of an ink onto a substrate using thick film printing to form a first ink deposit structure;
a.2) depositing a plurality of layers of an ink onto a substrate using thick film printing to form a second ink deposit structure positioned to oppose said first ink deposit structure; and
b) a second and subsequent pairs of ink deposits using thick film printing as described in a) aligned to oppose each other and along the length of the previous deposits so as to form an extension of said channel; and
c) placing a cover atop and between said first and second ink deposit structure so as to form a micro-channel defined between said opposing ink deposit structures, subsequent pairs, said substrate, and said cover.
